(19) United States
(12) Patent Application Publication
(10) Pub. No.: US 2016/0045910 A1
(43) Pub. Date: Feb. 18, 2016

(54) PROCESS FOR REJUVENATION OF A USED HYDROTREATING CATALYST

(71) Applicant: SHELL OIL COMPANY, Houston, TX (US)

(72) Inventors: Ali AZGHAY, Amsterdam (NL); Patricia Johanna Anne Maria GILTAY, Amsterdam (NL); Marcello Stefano RIGUTTO, Amsterdam (NL); Arend Jan VAN WELSENES, Amsterdam (NL); Ferry WINTER, Amsterdam (NL)

(21) Appl. No.: 14/779,673

(22) PCT Filed: Mar. 28, 2014
(86) PCT No.: PCT/EP2014/056274

§ 371 Date: Sep. 24, 2015

(30) Foreign Application Priority Data
Mar. 28, 2013 (EP) 13161608.8

(51) Int. Cl. B01J 38/62; B01J 23/94; B01J 38/12; C10G 65/00

(52) U.S. Cl. CPC B01J 38/62; C10G 65/00; B01J 23/94; B01J 38/12

(57) ABSTRACT

The invention provides a process for rejuvenation of a used hydrotreating catalyst comprising at least 8% wt of coke and one or more non-noble Group VIII and/or Group VIb metals, which process comprises the steps of: (i) removing coke from the used hydrotreating catalyst; and (ii) treating the catalyst obtained in step (i) with of from 2 to 60% wt of gluconic acid, based on weight of dry catalyst.

### FIELD OF THE INVENTION

The present invention relates to a process for rejuvenation of a used hydrotreating catalyst.

### BACKGROUND OF THE INVENTION

In refinery processes, feeds such as crude oil, distillates and residual crude oil fractions generally contain contaminants which tend to deactivate catalyst for chemical conversion of the feeds. Contaminants which are especially abundant are sulphur containing compounds, such as hydrogen sulphide and sulphur containing hydrocarbons, and nitrogen containing compounds.

Hydrotreating processes are used to remove such contaminants from refinery feedstocks and generally involve contacting the hydrocarbon feed in the presence of hydrogen with a hydrotreating catalyst under hydrotreating conditions. Besides contaminants removal, further conversions can take place such as hydrocracking and aromatics hydrogenation.

Hydrotreating catalysts comprise hydrogenation metal components on an oxidic carrier. The hydrogenation metal components are generally Group VI metal component such as molybdenum and/or tungsten and Group VIII metal components such as nickel and/or cobalt.

During operation various contaminants such as metal compounds (e.g. nickel and vanadium sulphides) and coke deposit on the hydrotreating catalysts with time causing catalyst deactivation. In order to continue to meet product specifications in terms of for instance nitrogen and sulphur contents in a hydrotreating process the hydrotreating catalyst needs to be replaced by new or fresh hydrotreating catalyst. Since new or fresh hydrotreating catalyst is expensive, deactivated catalyst is increasingly replaced by rejuvenated hydrotreating catalyst. In the regeneration step of a rejuvenation process coke deposits are removed and metal sulphides are converted to oxides during a controlled oxidation reaction. The catalyst so obtained will have recovered a percentage of its original activity.

In view of increasing demands for hydrotreating catalysts to prepare low sulphur and nitrogen fuels such as ultra low sulphur diesels and to meet stricter environmental regulations much focus is nowadays in refineries on the rejuvenation of hydrotreating catalyst to ensure that catalyst expenses are controlled.

Object of the present invention is therefore to provide a process for rejuvenating a used hydrotreating catalyst which is very attractive in terms of activity recovery.

### SUMMARY OF THE INVENTION

It has now been found that attractive activity of used catalyst can be realised when the used hydrotreating catalyst is subjected to a regeneration step and subsequently contacted with gluconic acid.

Accordingly, the present invention relates to a process for rejuvenation of a used hydrotreating catalyst comprising at least 8% wt of coke and one or more non-noble Group VIII and/or Group VIb metals, which process comprises the steps of:

(i) removing coke from the used hydrotreating catalyst; and
(ii) treating the catalyst obtained in step (i) with of from 2 to 60% wt of gluconic acid, based on weight of dry catalyst.

In accordance with the present process the hydrotreating activity of the used catalyst can be recovered to a very large extent. In some cases the hydrotreating activity can completely be recovered or even be increased when compared with the hydrotreating activity of the fresh unused catalyst. Hence, the present invention constitutes a considerable improvement over known processes for rejuvenating hydrotreating catalysts.

### DETAILED DESCRIPTION OF THE INVENTION

The present invention relates to a process for rejuvenation of a used hydrotreating catalyst which comprises at least 8% wt of coke and one or more non-noble Group VIII and/or Group VIb metals.

The hydrotreating catalyst to be rejuvenated in accordance of the present invention can be any known hydrotreating catalyst.

The hydrotreating catalyst to be used in step (i) can suitably be a hydrodesulphurisation catalyst. The hydrodesulphurisation catalyst may be any hydrodesulphurisation catalyst known in the art. Typically, these catalysts comprise a Group VIII metal of the Periodic Table and a compound of a Group VIB metal of the Periodic Table as hydrogenation components on a porous catalyst support. Suitable examples of porous catalyst supports include silica, alumina, titania, zirconia, silica-alumina, silica-titania, silica-zirconia, titania-alumina, zirconia-alumina, silica-titania and combinations of two or more thereof. The preferred porous catalyst support is selected from the group consisting of alumina, silica, and silica-alumina. Among these, the most preferred porous refractory oxide is alumina, and more specifically gamma alumina.

The porous catalyst carrier may have an average pore diameter in the range of from 50 to 200 Å, measured according to ASTM test D-4222. The total pore volume of the porous refractory oxide is preferably in the range of from 0.2 to 2 cc/gram.

The surface area of the porous refractory oxide, as measured by the B.E.T. method, generally exceeds 100 m²/gram, and it is typically in the range of from 100 to 400 m²/gram. The surface area is to be measured by the BET method according to ASTM test D3663-03.

The metal elements of the metal components are those selected from Group VIB, preferably chromium, molybdenum and tungsten, and Group VIII, preferably cobalt and nickel, of the Periodic Table of the Elements as described in the Handbook of Chemistry and Physics 63^{rd} Edition. Phosphorous may also be a desired component.

The metal component can be the metal per se or any component containing the metal, including but not limited to metal oxides, metal hydroxides, metal carbonates and metal salts.

For the Group VIII metals, the metal components preferably are chosen from the group consisting of Group VIII metal acetates, formates, citrates, oxides, hydroxides, carbonates, nitrates, sulfates, and two or more thereof. Preferably, the Group VIII metal components are metal nitrates, more specifically nitrates of nickel and/or cobalt. For the Group VIB metal components, the preferred components are chosen from the group consisting of Group VIB metal oxides and sulfides.

The Group VIII metal component, more specifically cobalt and/or nickel, preferably, cobalt, can be present in the hydrotreating catalyst in an amount in the range of from 0.5 wt % to 20 wt %, preferably from 1 wt % to 15 wt %, and, most preferably, from 2 wt % to 12 wt %, based on total dry weight of the hydrotreating catalyst.

The Group VIB metal component, more specifically molybdenum and/or tungsten, preferably, molybdenum, can be present in the hydrotreating catalyst in an amount in the range of from 5 wt % to 50 wt %, preferably from 8 wt % to 40 wt %, and, most preferably, from 10 wt % to 30 wt %, based on total dry weight of hydrotreating catalyst.

The fresh unused hydrotreating catalyst which after use in hydrotreating is subjected to the process for the present invention, is suitably prepared by a process comprising the steps of:

(a) treating a carrier with one or more Group VIB metal components and/or one or more Group VIII metal components;
(b) calcining the treated catalyst carrier at a temperature of at least 200° C., preferably of from 200 to 700° C., to form an impregnated carrier; and
(c) sulphiding the impregnated carrier to obtain the hydrotreating catalyst.

This fresh hydrotreating catalyst subsequently is used in a hydrotreating process. The activity of the fresh hydrotreating catalyst declines during the hydrotreating process due to the deposition of coke and possibly other contaminants onto the surface of the hydrotreating catalyst. The used catalyst to be rejuvenated in accordance with the present invention comprises at least 8% wt coke, based on total weight of the used catalyst. The used hydrotreating catalyst may well contain up to 30% wt of coke, and typically contains between 8 and 20% wt of coke, based on total weight of the used catalyst. The removal of coke from the used hydrotreating catalyst is therefore an important step in the rejuvenation process of a used hydrotreating catalyst.

In step (i) of the present process, coke is removed from the used hydrotreating catalyst.

Step (i) can suitably be carried out in a reactor other than the reactor in which the hydrotreating process has been carried out. In other words, the used hydrotreating catalyst is suitably removed from the reactor in which the hydrotreating is carried out and transported to a regeneration unit in which step (i) is carried out.

Step (i) is typically established by burning off the coke at an elevated temperature in oxidizing conditions. Suitably, in step (i) use is made of oxygen or an oxygen-containing gas. In this way the coke can be removed by burning carbonaceous species that that are present on the hydrotreating catalyst.

Before the used hydrotreating catalyst is subjected to step (i) it can be subjected to a treatment in which smaller, pulverized catalyst particles are separated from the reusable catalyst particles. This can for instance be established by means of a sieve. In addition, the used hydrotreating catalyst can also be subjected to a deoiling step before it is subjected to step (i). In such deoiling step, oil which is still present on the used hydrotreating catalyst can be removed from the used hydrotreating catalyst. Deoiling processes are as such well known.

Step (i) can suitably be carried out by heating the used hydrotreating catalyst in the presence of an oxygen-containing gas at a temperature in the range of from 200 to 750° C. Preferably, in step (i) the coke is removed by contacting the used hydrotreating catalyst with an oxygen-containing gas at a temperature in the range of from 250 to 700° C., more preferably 320 to 550° C., and most preferably 330 to 470° C. Step (i) is preferably carried out using an oxygen-containing gas, such as air or nitrogen-diluted air, so as to oxidize the carbonaceous deposits to carbon oxides (CO2 and/or CO) and to substantially convert metal sulfides to metal oxides. Preferably, the oxygen-containing gas is air. Preferably, a stream of the oxygen-containing gas is applied. Generally, step (i) is terminated when the amount of carbon oxides (CO and/or CO2) in the off-gas is low enough to indicate that a substantial part of the carbonaceous deposits have been burned off.

In a preferred embodiment of the present process, prior to step (i) the used hydrotreating catalyst is subjected to a heat treatment in an inert atmosphere, e.g. a nitrogen atmosphere, whereafter the hydrotreated catalyst obtained is subjected to step (i). Preferably, such heat treatment in inert atmosphere is carried out at a temperature in the range of from 250 to 700° C., more preferably 320 to 550° C., and most preferably 330 to 470° C.

Step (i) can suitably be carried out for a period of time of at least 0.5 hours, preferably at least 2.5 hours, and more preferably at least 3 hours.

The hydrotreating catalyst as obtained in step (i) suitably comprises less than 5% wt of coke, preferably less than 3% wt of coke, and more preferably less than 2% wt of coke, based on the total weight of the hydrotreated catalyst.

In step (ii), the catalyst as obtained in step (i) is treated with of from 2 to 60% wt of gluconic acid.

Preferably, the catalyst is treated with a solution of gluconic acid more specifically a solution containing of from 2 to 60% wt of gluconic acid. The volume of the solution preferably is the pore volume of the catalyst.

The solution to be used preferably comprises an amount of gluconic acid which is 3 to 50% wt, more preferably 4 to 40% wt, and most preferably 6 to 30% wt based on weight of catalyst.

Preferably, the molar ratio of gluconic acid to the total Group VIB and Group VIII metal content in the hydrotreating catalyst is of from 0.01 to 2.5.

Step (ii) is suitably be carried out over a period of time in the range of from 0.1 to 24 hours, preferably in the range of from 0.25 to 12 hours, and more preferably in the range of from 0.5 to 6 hours.

Step (ii) is suitably carried out at a temperature in the range of from 10 to 90° , preferably in the range of from 15 to 80° C., and more preferably in the range of from 20 to 70° C.

After step (ii), the gluconic acid treated catalyst can suitably be subjected to a drying step which is carried out at a temperature of at most 200° C. to form a dried hydrotreating catalyst. Typically, the drying temperature will be conducted at a temperature in the range of from 60 to 150° C.

A major advantage of the present process is that a single treatment in accordance with step (ii) enables one to recover the activity of the used catalyst to a very large extent whilst the process is very simple and cost-effective. Suitably, in accordance with the present invention at least 85%, preferably at least 90%, more preferably at least 95%, and most preferably at least 98% of the activity of the hydrotreating catalyst is recovered. In some cases the hydrotreating activity can completely be recovered or even be increased when compared with the hydrotreating activity of the fresh unused catalyst. The use of the gluconic acid enables a most attractive recovery of hydrodesulphurisation activity of the hydrotreating catalyst, which is believed to be due to the fact that the solution of the gluconic acid brings about a redispersion of the hydrogenation metal components on the surface of the used hydrotreating catalyst.

The present invention also provides a process for hydrotreating a sulphur-containing hydrocarbon feedstock which process comprises contacting the hydrocarbon feedstock at a hydrogen partial pressure from 1 to 70 bar and a temperature of from 200 to 420° C. with a rejuvenated catalyst as obtained in accordance with the present invention.

The hydrotreating catalyst obtained after step (ii), and optionally a drying step, can be sulphided before it is reused in a hydrotreating process. Before such a sulphidation step the hydrotreating catalyst can suitably be calcined to convert the hydrogenation metal components into their oxides. Subsequently, the calcined hydrotreating catalysts can then be subjected to a sulphidation treatment. Sulphidation of the rejuvenated catalyst can be done using any conventional method known to those skilled in the art. Thus, the rejuvenated catalyst can be contacted with a sulphur-containing compound which is decomposable into hydrogen sulphide, under the contacting conditions of the invention. Examples of such decomposable compounds include mercaptans, CS₂, thiophenes, dimethyl sulfide (DMS), and dimethyl disulphide (DMDS). Also, preferably, the sulphiding is accomplished by contacting the composition, under suitable sulphurization treatment conditions, with a hydrocarbon feedstock that contains a a sulphur-containing compound. The sulphur-containing compound of the hydrocarbon feedstock can be an organic sulphur compound, particularly, one which is typically contained in petroleum distillates that are processed by hydrodesulphurization methods. Typically, the sulphiding temperature is in the range of from 150 to 450° C., preferably, from 175 to 425° C., and, most preferably, from 200 to 400° C.

The sulphiding pressure can be in the range of from 1 bar to 70 bar, preferably, from 1.5 bar to 55 bar, and, most preferably, from 2 bar to 45 bar.

Preferably, the sulphidation is a liquid phase sulphidation.

The following examples are presented to further illustrate the invention, but these are not to be construed as limiting the scope of the invention.

### EXAMPLES

### Example 1—Conventional Rejuvenation

Commercial 1.3 mm trilobe alumina carriers were subjected to pore volume impregnation with a metal containing solution to yield the following metals composition (weight of metal based on total dry weight of catalyst): 14% wt Mo, 3.5% wt Co, 2.25% wt P. The impregnated carrier was dried at 110° C. for 2 hours and subsequently calcined for 2 hours at a temperature above 300° C. (Catalyst A). This catalyst was used during 1000 hours in a hydrotreating process, and part of this used catalyst is subsequently subjected to coke-burn at 357° C. (catalyst B) while another part to coke-burn at 450° C. (catalyst C) to achieve a coke level of between 1 and 2% wt.

### Example 2—Rejuvenation According to the Invention

Part of catalyst B obtained in Example 1 was subsequently treated with an aqueous gluconic acid solution containing 15% wt of gluconic acid based on amount of dry catalyst (Catalyst D).

### Example 3—Catalyst Activities

The rejuvenated catalysts were conditioned and sulfided by contacting with a liquid hydrocarbon containing sulfur spiking agent to provide a sulfur content of 2.5% wt. The process conditions used in these tests comprise a gas to oil ratio of 300 Nl/kg, a pressure of 40 bar and a liquid hourly space velocity of 1 h⁻¹. The weight average bed temperature (WABT) was adjusted to a temperature in the range of 340 to 380° C.

The feed used in the tests is a full range gas oil containing 1.28% wt of sulphur.

The process conditions and feed properties are representative of typical ultra-low sulfur diesel (ULSD) operations.

The temperature required to obtain a product containing 10 ppm of sulphur is given in Table 1. The lower temperature required to achieve this sulphur content shows that the catalyst rejuvenated according to the present invention has improved performance over catalysts rejuvenated in the conventional way.

TABLE 1
Hydrodesulphurization activity

| | Temperature required |
|---|---|
| Catalyst | for 10 ppm S (° C.) |
| A | 361 |
| B | 359 |
| C | 363 |
| D | 353 |

1. A process for rejuvenation of a used hydrotreating catalyst comprising at least 8% wt of coke and one or more non-noble Group VIII and/or Group VIb metals, which process comprises the steps of:
(i) removing coke from the used hydrotreating catalyst; and
(ii) treating the catalyst obtained in step (i) with of from 2 to 60% wt of gluconic acid, based on weight of dry catalyst.

2. A process according to claim 1, in which process coke is removed by contacting the used hydrotreating catalyst with an oxygen-containing gas at a temperature of from 200 to 750° C.

3. A process according to claim 1, in which process the catalyst obtained in step (i) contains of from 0 to 10% wt of coke.

4. A process according to claim 1, in which the solution is an aqueous solution containing of from 3 to 40% wt of gluconic acid.

5. A process according to claim 1, in which the carrier is alumina.

6. A process according to claim 5, in which the carrier is gamma alumina.

7. A process according to claim 1, in which the molar ratio of compound (I) to the total Group VIB and Group VIII metal content is of from 0.01 to 2.5.

8. A process for hydrotreating a sulphur-containing hydrocarbon feedstock which process comprises contacting the hydrocarbon feedstock at a hydrogen partial pressure from 1 to 70 bar and a temperature of from 200 to 420° C. with a rejuvenated catalyst as obtained according to any one of the preceding claims.

9. A process according to claim 1 in which the fresh hydrotreating catalyst had been obtained by
(a) treating a carrier with one or more Group VIB metal components and/or one or more Group VIII metal components,
(b) calcining the treated catalyst carrier at a temperature of at least 200° C. to form an impregnated carrier, and
(c) sulphiding the impregnated carrier to obtain the hydrotreating catalyst.
